(19) United States
(12) Patent Application Publication
(10) Pub. No.: US 2015/0211448 A1
(43) Pub. Date: Jul. 30, 2015

(54) ENGINE CONTROL VALVE HAVING IMPROVED SEALING

(71) Applicant: Département Propriété Intellectualle, Immeuble, Cergy Saint Christophe (FR)

(72) Inventor: Grégory Hodebourg, Sartrouville (FR)

(21) Appl. No.: 14/414,176

(22) PCT Filed: Jul. 15, 2013
(86) PCT No.: PCT/FR2013/051693

§ 371 Date: Jan. 12, 2015

(30) Foreign Application Priority Data
Jul. 16, 2012 (FR) 1256856

(51) Int. Cl. F02M 25/07

(52) U.S. Cl. CPC F02M 25/0793

(57) ABSTRACT

The invention relates to an engine control valve which includes a body defining an inner duct and a rotatably mobile shutter (1), said shutter (1) being capable of pivoting between an open position enabling gas to flow into the duct and a closed position sealing the duct, the valve including a first system (2, 4) for sealing the duct relative to the outside of the body and a second sealing system (3), separate from the first, and ensuring that the shutter (1) is sealed when in the closed position thereof.

The invention relates to an engine control valve having improved sealing. This type of valve may for example be fitted in a gas supply circuit of a vehicle combustion engine, in order to regulate the flow rate of the EGR (Exhaust Gas Recirculation) gases in a loop making it possible to bleed a part of the exhaust gases leaving the engine so as to reinject them upstream of said engine. The operating principle of this type of valve is based on the controlled rotation of a flap which can move from a completely open position for allowing the gases to pass through to a closed position for blocking this passage. The subject of the invention is an engine control valve having improved sealing.

An engine control valve thus has a flap which is mounted in a pivoting manner on a rotary pin. The flap may comprise a first part and a second part that are separated by said pin. When this flap is in a closed position, it comes into contact with a gasket that is secured to the body of the valve, said gasket sealing the valve by acting as a positioning end stop for said flap.

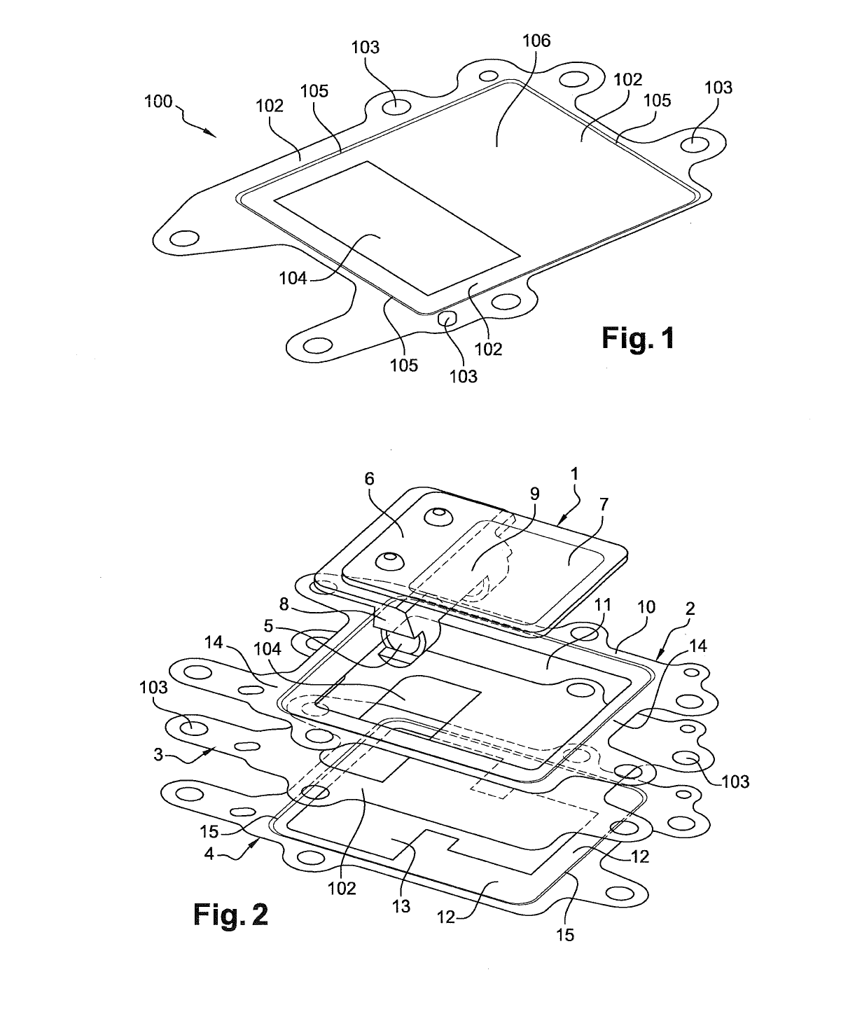

With reference to FIG. 1, such a gasket 100 is flat overall and is fastened in the body of the valve by being inserted at a peripheral region 102 between two cast elements of said body. This peripheral region 102 has a plurality of orifices 103 that are each intended to be passed through by a screw so that said gasket 100 is fastened between said cast elements. This gasket 100 has an opening 104 and a solid portion 106, and when the flap is in the closed position, the first part of the flap comes into contact with one of the two faces of the gasket 100 in order to close off said opening 104, while the second part of said flap is flush with the other face of said gasket 100 at the solid portion 106. Generally, such a gasket 100 is provided with a peripheral lip 105 that is able to deform under the effect of clamping together of the two cast elements, while the gasket 100 is being fastened in the valve.

A major drawback caused by the mounting of such a gasket is that there is a risk that the central region of said gasket 100, said central region needing to interact with the flap in order to seal the valve, will move slightly under the effect of the deformation of the peripheral lip brought about by the clamping between the two cast elements, thus impairing the quality of sealing of the valve. In other words, the final position of the gasket, once it has been fastened between these cast elements, is offset from its ideal pre-positioning in the valve prior to mounting. Thus, in order that proper sealing is provided between the gasket and the cast elements, there is a risk that the sealing between said gasket and the flap will be impaired.

The subject of the invention, according to one of its aspects, is an engine control valve comprising a body that delimits an internal duct, and a rotationally mobile flap, said flap being able to pivot between an open position allowing a gas to pass through the duct and a closed position closing off the duct,

the valve comprising a first sealing system for sealing the duct with respect to the outside of the body, and a second sealing system, separate from the first, for sealing the flap when it is in the closed position.

According to the above aspect of the invention, the sealing of the duct with respect to the outside of the body, also referred to as “external sealing of the valve” in the following, is decoupled from the sealing of the flap when it is in the closed position, also referred to as “internal sealing of the valve” in the following. The internal sealing and external sealing are thus provided by different means. Since each of these means is dedicated to a specific type of sealing, it may be chosen in dependence on this type of sealing, such that each type of sealing can be provided optimally, unlike the case where one and the same means provides both the external sealing and the internal sealing of the valve.

According to one exemplary embodiment of the invention, the second sealing system may be formed by a sealing gasket that is secured to the body of the valve, this gasket having an opening that is closed off by the flap when it is in the closed position.

Still according to this exemplary embodiment of the invention, the body may comprise two elements, notably cast elements, and the first sealing system may comprise two connecting gaskets that come into contact respectively with one of these elements. The first sealing system thus provides sealing with respect to external fluid(s) that is/are likely to reach the duct from the outside of the body by passing between the cast elements.

The invention is not limited to decoupling of the internal sealing with respect to the external sealing of the valve by virtue of the above gaskets. In a variant, the second sealing system may be formed by virtue of the cooperation between the flap and the cast elements when the flap is in the closed position.

The sealing gasket may be inserted between the two connecting gaskets.

The sealing gasket may be strictly flat over its entire surface. The expression “strictly flat” means that this gasket does not have a peripheral lip and is perfectly flat without any visible reliefs. The three gaskets are preferably made of stainless steel. The two connecting gaskets may optionally be covered with a rubber material. When the sealing gasket is “sandwiched” between the two connecting gaskets, it is thus not in direct contact with the cast elements, and each connecting gasket is in contact with said sealing gasket and a cast element. Advantageously, the three gaskets are ideally superposed.

The engine control valve according to the above exemplary embodiment thus comprises a second sealing system in the form of a gasket designed such that the fastening thereof between two cast elements has no influence on its interaction with the flap for closing off said valve in order to provide internal sealing. In this way, once the gasket has been pre-positioned in the valve in an ideal position for providing optimal interaction with the flap, clamping between the two cast elements in order to definitively fasten said gasket in the valve will have little if any impact on the final positioning of said gasket in the valve. The valve can thus have well-controlled internal sealing.

Each connecting gasket may have a peripheral lip. In a variant, each connecting gasket may be a flat annular gasket.

In the above exemplary embodiment, the forces arising from the clamping between the two cast elements for fastening the sealing gasket will bear on the connecting gaskets that provide the external sealing, if appropriate via their peripheral lips, which will react by deforming, thereby preserving the structural integrity of the sealing gasket inserted between said connecting gaskets. In other words, the sealing gasket, the positioning of which in the valve requires great precision, will be moved little, if at all, while it is being fastened in the valve, under the effect of the stresses brought about by the clamping of the cast elements. In this way, the presence of the connecting gaskets makes it possible to decouple the interaction of the sealing gasket with the cast elements from the interaction of said sealing gasket with the flap.

The connecting gaskets may be arranged around the sealing gasket such that their peripheral lip spaces them apart from said sealing gasket. For this configuration, the sealing gasket is in contact with the two connecting gaskets at their peripheral regions that are inserted between the two cast elements, the two connecting gaskets being spaced apart from said sealing gasket at their internal part.

Advantageously, the sealing gasket and the two connecting gaskets are inserted between the two cast elements at a peripheral region of said gaskets. This peripheral region may correspond, for each gasket, to an annular region farthest from the center of said gasket. In this way, the peripheral region of each gasket is dedicated to the fastening of said gaskets in the valve, while their central part cooperates with the flap so as to provide proper sealing of the valve.

Preferably, the sealing gasket has a central part delimited externally by the peripheral region, said central part comprising the opening and a solid portion, said central part and said peripheral region being placed strictly on the same plane. A strictly flat gasket is quick and easy to manufacture since it does not require any stamping phase for creating a relief, for example a peripheral lip.

Advantageously, at least one of the two connecting gaskets has an annular shape. Specifically, since the connecting gaskets preferably only have a function of absorbing force in their peripheral region, it is possible to prevent said connecting gaskets from extending significantly toward the interior of their peripheral region.

Advantageously, the peripheral region of each gasket is provided with orifices for mounting them between the two cast elements by way of independent fastening means. When the three gaskets are designed to be superposed, the orifices can be located at the same locations on each gasket, such that they correspond ideally at the time they are fastened between the two cast elements. The independent fastening means may be formed for example by screws.

Preferably, the flap comprises a rotary pin that separates said flap into a first part, which is notably flat, and a second part, which is notably flat, the first part of said flap closing off the opening in the sealing gasket when the flap is in a closed position. Specifically, mounting three superposed gaskets is particularly suitable for a valve that operates with a two-part flap. The two parts may be flat, in perfect continuity of one another, and rigidly fastened together.

Preferably, the second part of the flap is flush with a solid portion of the sealing gasket that partially delimits the opening, when the flap is in a closed position.

Advantageously, the first part of the flap comes into contact with a face of the sealing gasket in order to close off the opening, the second part of said flap being flush with the opposite face of said gasket at the solid portion, when the flap is in an open position.

Advantageously, the flap comprises a bulge placed between the second part and the rotary pin, said bulge being positioned so as to remain in contact with the solid portion of the sealing gasket when the flap pivots between an open position and a closed position or vice versa. Specifically, since the sealing gasket is inserted at its peripheral region between two cast elements of the body of the valve, its central part forms a region of structural weakness that is likely to deform under the effect of the high temperature and high pressure of the gases flowing through said valve, with the consequence of the creation of leakage passages for said gases and the possible prevention of said flap from rotating. The bulge thus acts as a permanent support for the central part of the gasket, remaining in contact with the solid portion of the gasket throughout the pivoting of the valve in order to pass from a closed position to an open position, or vice versa. This bulge thus acts as a contact stop intended to prevent any deformation of the solid portion of the gasket at any time during the rotation of the flap. Such a bulge makes it possible to preserve the geometric integrity of the gasket and thus to ensure proper operation of the valve and also proper sealing thereof.

Preferably, the cross section of the bulge is delimited by a rectilinear segment and a curved segment, the two ends of which join the two ends of said rectilinear segment. The rectilinear segment corresponds to the base of the bulge by way of which said bulge is on the flap, and the rounded segment corresponds to the outer surface of the bulge, which protrudes from said flap.

According to a preferred embodiment of a valve according to the invention, the bulge is in the form of a half cylinder. This is the particular case in which the curved segment delimits a semicircle, that is to say that the bulge is rounded.

The valves according to the invention have the advantage of being effective in terms of operation, preventing the deformation of the gasket in a simple and appropriate manner while it is being fastened in the body. In this way, said gasket will be positioned in a strict and precise manner, without any fluctuation at the time it is mounted in the valve. Said valves moreover have the advantage of remaining at a constant size with respect to the pre-existing valves, since the added parts, which are formed essentially by the two additional gaskets, have a very small thickness and a small extent.

A detailed description of a preferred embodiment of a valve according to the invention is given in the following text with reference to the appended drawings, in which:

FIG. 1 is a perspective view of a prior art gasket,

FIG. 2 is an exploded view of an assembly that is made up of three superposed gaskets and a flap and is employed in a valve according to the invention, and

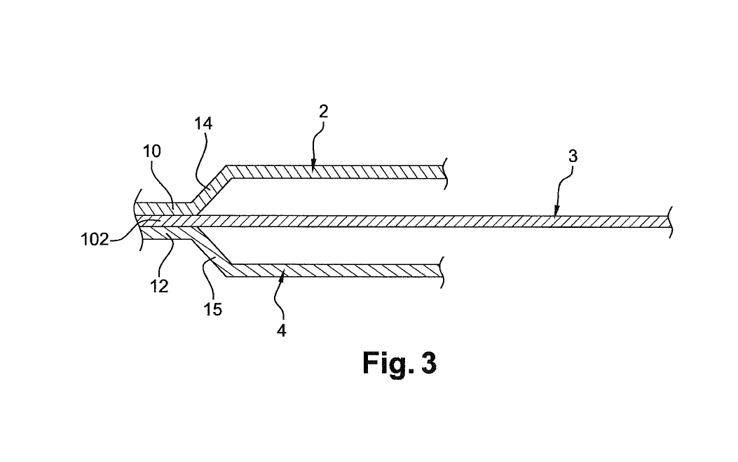

FIG. 3 is a schematic cross-sectional view of the interaction between the three gaskets of a valve according to the invention.

FIG. 1 has already been described. The elements in common between said figure and the other figures retain the same references.

An engine control valve according to the invention can be for example an EGR valve that regulates the flow rate of the gases through a loop connecting an exhaust circuit to an air intake circuit of a vehicle combustion engine.

With reference to FIG. 2, an engine control valve according to the invention employs a flap 1 and three gaskets 2, 3, 4 that are intended to be inserted between two cast elements of the body of said valve. The flap 1 comprises a rotary pin 5 and also a first part 6 and a second part 7, said parts 6, 7 being placed on either side of said pin 5 in continuity of one another. These two parts 6, 7 have a small thickness and are fastened rigidly together. The overall contour of the flap 1 delimited by these two parts 6, 7 is approximately rectangular, each of said parts 6, 7 also having a rectangular shape.

The rotary pin 5 is offset with respect to a plane including the two parts 6, 7 and is located at the end of a lever arm 8 extending substantially perpendicularly to said plane, said arm 8 originating at the imaginary interface plane between said parts 6, 7. The term “imaginary” means that no particular mark precisely indicates the location of the interface plane on the flap 1 between the two parts 6, 7. The flap 1 comprises a rounded bulge 9 placed on the lever arm 8 between the second part 7 and the rotary pin 5, said bulge 9 extending parallel to said pin 5. The bulge 9 protrudes from the lever arm 9 parallel to the second part 7 and has a cross section delimited by a rectilinear segment and a curved segment, the two ends of which join the two ends of said rectilinear segment. The rectilinear segment corresponds to a flat base of the bulge 9 by way of which it is joined to the lever arm 8, and the curved segment corresponds to the rounded outer surface of said bulge 9.

A valve according to the invention also comprises three gaskets 2, 3, 4, one of which represents a sealing gasket 3 that is able to cooperate with the flap 1 in order to provide the internal sealing of the valve when the latter is in a closed position, the two other gaskets 2,4 forming connecting gaskets for fastening the sealing gasket 3 in the valve and for providing the external sealing of the valve. Unlike the gasket 100 shown in FIG. 1, the sealing gasket 3 is perfectly flat since it does not have a peripheral lip. One 2 of the two connecting gaskets is annular and is formed essentially by a peripheral region 10 that delimits a wider opening 11 than the one 104 in the connecting gasket 3. This peripheral region 10 is annular in this example and is provided with a peripheral lip 14.

The peripheral region 10 of this connecting gasket 4 has, in the example in question, the same geometry and the same dimensions as those of the peripheral region 102 of the sealing gasket 3. The other connecting gasket 4 is annular overall and is formed by a peripheral region 12 that delimits a profiled opening 13, the dimensions of which are larger than those of the opening 104 in the sealing gasket 3. The peripheral region 12 of this other connecting gasket 4 is provided with a peripheral lip 15 and has the same geometry and the same dimensions as those of the peripheral region 102 of the sealing gasket 3. The peripheral regions 10, 102, 12 of the three gaskets 2, 3, 4 are provided with orifices 103 placed at the same location, such that, when said three gaskets 2, 3, 4 are ideally superposed, their peripheral regions 10, 102, 12 and thus their orifices 103 correspond to one another. These orifices 103 are intended to be passed through by screws in the example described so as to fasten the three gaskets 2, 3, 4 between the two cast elements of the body of the valve.

These three gaskets 2, 3, 4 are placed between the two cast elements at their peripheral region 10, 102, 12, ideally being superposed, the sealing gasket 3 being placed between the two connecting gaskets 2, 4, and each of said connecting gaskets 2, 4 being in contact with a different cast element. In this superposed configuration, the orifices 103 for fastening the three gaskets 2, 3, 4 correspond perfectly to one another.

With reference to FIG. 3, the peripheral region 10, 12 of each connecting gasket 2, 4 comes into contact with a face of the peripheral region 102 of the sealing gasket 3, and the peripheral lips 14, 15 of each of said connecting gaskets 2, 4 tend to space apart each of said connecting gaskets 2, 4 from said central sealing gasket 3. Thus, when the two cast element are going to be clamped, the two connecting gaskets 2, 4 will absorb the forces produced during this clamping, by deforming at their peripheral lip 14, 15, thereby preserving the structural integrity of the sealing gasket 3.

With reference to FIG. 2, the flap 1 shown therein is able to pivot between a completely open position, in which the gases can pass through the valve at a maximum flow rate, and a closed position, in which the first portion 6 of the flap 1 comes into contact with a face of the sealing gasket 3 in order to close off the opening 104 in said gasket 3, and in which the second part 7 of the flap 1 is flush with the opposite face of said gasket 3 at the solid portion 106. The bulge 9 of the flap 1 is in contact with that part of the solid portion 106 of the gasket 3 that partially borders the opening 104, and when the flap 1 pivots in one direction or the other in order to open or close, said bulge 9 remains in contact with said solid portion throughout the rotation of said flap 3. In this way, the bulge 9 acts as a holding part for the region of the sealing gasket 3 which is most likely to deform by thermal expansion, on account of the presence of hot gases in the valve.

The presence of the two connecting gaskets 2, 4 preserves the integrity of the sealing gasket 3, by preventing the position of said gasket 3 from fluctuating while it is fastened between the two cast elements of the body of the valve.

The invention is not limited to the example which has just been described. The decoupling between the internal sealing and the external sealing of the valve can be obtained in some other way than by virtue of the gaskets 2 to 4 which have just been described.

In a variant that is not shown, the sealing gasket 3 is as described above but the connecting gaskets 2 and 4 are annular and can have no peripheral lip, then being flat.

In another variant that is not shown, the connecting gaskets 2 and 4 can be as described above and no sealing gasket 3 is used, the internal sealing then being obtained by virtue of the cooperation between the flap 1 and the body 2.

1. An engine control valve comprising:
a body that delimits an internal duct;
a rotationally mobile flap, said flap being able to pivot between an open position allowing a gas to pass through the duct and a closed position closing off the duct;
a first sealing system for sealing the duct with respect to the outside of the body, and a second sealing system, separate from the first, for sealing the flap when it is in the closed position, the second sealing system being formed by a sealing gasket that is secured to the body of the valve, this gasket having an opening that is closed off by the flap when in the closed position,
the flap comprising a rotary pin that separates said flap into a first part and a second part, the first part of said flap closing off the opening in the sealing gasket when the flap is in a closed position,
the second part of the flap being flush with a solid portion of the sealing gasket that partially delimits the opening, when the flap is in the closed position.

2. The valve as claimed in claim 1, wherein the body comprises two cast elements, the first sealing system comprising two connecting gaskets that come into contact respectively with one of the cast elements.

3. The valve as claimed in claim 2, wherein the sealing gasket is inserted between the two connecting gaskets.

4. The valve as claimed in claim 3, wherein the sealing gasket is strictly flat over its entire surface and each connecting gasket has a peripheral lip.

5. The valve as claimed in claim 4, wherein the connecting gaskets are arranged around the sealing gasket such that their peripheral lip spaces them apart from said sealing gasket.

6. The valve as claimed in claim 2, wherein the sealing gasket and the two connecting gaskets are inserted between the two cast elements at a peripheral region of said gaskets.

7. The valve as claimed in claim 6, wherein the sealing gasket has a central part delimited externally by the peripheral region, said central part comprising the opening and a solid portion, said central part and said peripheral region being placed strictly on the same plane.

8. The valve as claimed in claim 2, wherein at least one of the two connecting gaskets has an annular shape.

9. The valve as claimed in claim 1, wherein the first part of the flap comes into contact with a face of the sealing gasket in order to close off the opening, the second part of said flap being flush with the opposite face of said gasket at the solid portion, when the flap is in an open position.

10. The valve as claimed in claim 1, wherein the flap comprises a bulge placed between the second part and the rotary pin, said bulge being positioned so as to remain in contact with the solid portion of the sealing gasket when the flap pivots between an open position and a closed position or vice versa.

11. The valve as claimed in claim 1, wherein the first part and the second part of the flap are flat.
